(19) United States
(12) Patent Application Publication
(10) Pub. No.: US 2010/0233321 A1
(43) Pub. Date: Sep. 16, 2010

(54) PROCESS FOR PRODUCING A FEED COMPOSITION FOR CATTLE

(75) Inventors: James S. Drouillard, Olsburg, KS (US); Urs Wüest, Kronbuhl (CH); Brandon Depenbusch, Wamego, KS (US); Roland Strabler, Kaisten (CH)

Correspondence Address: MERCHANT & GOULD PC, P.O. BOX 2903, MINNEAPOLIS, MN, 55402-0903, US

(73) Assignees: Buhler AG, Uzwil (CH); Kanasa State Unversity Research Foundation, Manhattan, KS (US)

(21) Appl. No.: 12/303,683

(22) PCT Filed: Oct. 2, 2006
(86) PCT No.: PCT/CH2006/000530

§ 371 Date: Dec. 5, 2008

(30) Foreign Application Priority Data
Jun. 6, 2006 (DE) 10 2006 026 511.4

(51) Int. Cl. A23K 1/00; A23L 1/30

(52) U.S. Cl. 426/72; 426/511; 426/623

(57) ABSTRACT

A process produces a feed composition for cattle or the like, in particular a fattening feed, wherein conventional feed is intended to be replaced. First a premix (1) of cereal components, fat, molasses, vitamins, minerals and/or other ingredients is mixed and conditioned with addition of steam (7) and water (6) and subsequently fed to a mechanical and/or thermal treatment where the mixture is heated, processed and shaped to form porous lumps.

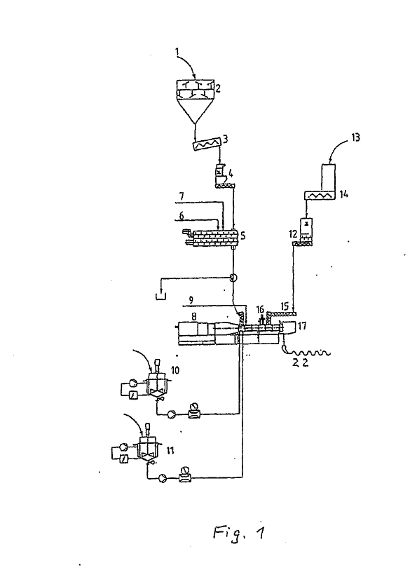

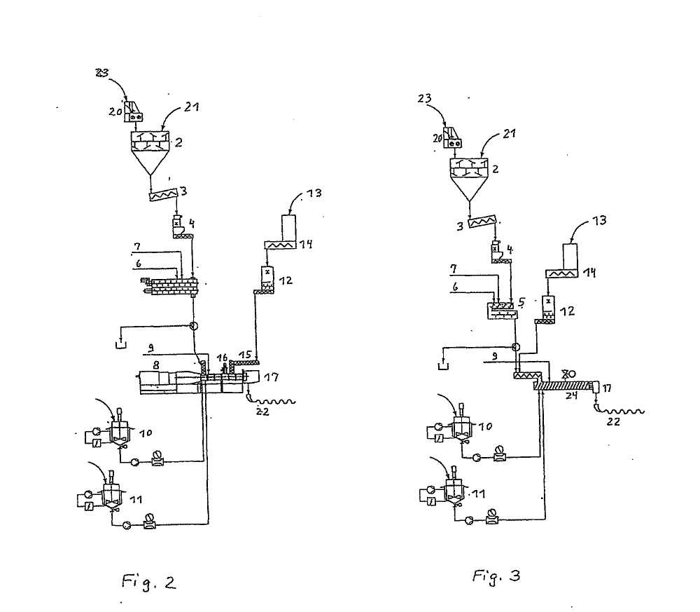

The invention relates to a method for the manufacture of a compound feed for cattle or the like, and in particular for the fattening of cattle.

It is customary to manufacture animal feed by extrusion. The manufacture of a soft, expanded and fatty PET feed with a crumbly structure is thus described in DE-A-2346830, the feed containing a farinaceous and proteinaceous raw material in addition to fat. The ingredients are mixed together and are brought to a moisture content of approx. 20-35% by weight. The mixture is thoroughly kneaded mechanically under increased pressure and is heated to a temperature above 100° C. until the mixture assumes a free-flowing state. The extrusion/expansion process then takes place, so that a feed with an expanded structure and a crumbly texture is produced. In a further extrusion process according to DE-A-3222646, a liquid additive in the expander is sprayed into a mixture, so that the additive diffuses uniformly through the expanded product after the expansion of the mixture.

Described in DE-A-2257108 is a feed which, in addition to cereal grain, also contains hay and silo fodder and a nitrogenous, non-protein substance, for example urea or the like (15-47.5% by weight), as well as a liquid-absorbent inert substance (e.g. betonite). The mixture is heated to a temperature of up to 160° C. under increasing pressure, compressed, and then expanded to produce a gelatinized product having a moisture content of less than 13%. The intention is to achieve a feed with a neutral pH value.

Cattle feed, in particular for the fattening of cattle, exhibits a high proportion of maize, silage and fibres, including hay (which is expensive), among other things in the form of a loose mixture. This feed is ignored selectively by the animal. Only the maize is broken up, for example by steaming and flaking, and the remaining feed components undergo no further preparation.

The object of the invention is to develop a method for the manufacture of a compound feed for cattle and the like, and in particular for fattening, which does not require to be cooled or dried following a treatment, and which is homogeneous, readily digestible and nutritious. The intention is to permit better feed utilization and feed conversion.

The object is achieved with the characterizing features of Patent claim 1. The ingredients in the compound feed in this case can typically be treated mechanically and/or thermally.

Advantageous embodiments are disclosed in the dependent Claims.

The feed can thus be processed mechanically and subjected to short-duration treatment at high temperature, and the treatment can take place in one or several stages.

The feed in the form of agglomerated pellets having a low density should be able to contain 0-50% of straw, in particular wheat straw, in addition to cereal grain, sorghum, molasses, fat, vitamins, water, minerals, fibres and other supplements. In the case of pellets having dimensions of approx. 1-7 cm, the length of the straw or hay fibres can be approx. 1-10 cm.

The ingredients of the feed are mixed, followed by conditioning in the customary manner, and the mixture is then agglomerated into porous pellets by expansion and short-duration treatment at high temperature, etc. There is no need for subsequent drying or cooling of the dietetic cattle feed produced in this way.

The new product form permits the replacement of conventional feed. This new feed is eaten complete with all of its ingredients and permits better nutritional intake and conversion and, on the other hand, the ability to avoid expensive (e.g. maize or lucerne) and/or less nutritious (e.g. hay) ingredients. The improved digestibility and conversion of the feed increases the efficiency with which the cattle are fattened. It is also possible to replace lucerne with straw (wheat straw or the like).

The feed then exits from the extruder 8 through an outlet orifice (not designated in more detail here) as a strand, which is reduced to the size of pellets by means of a cutting device 17.

### EXAMPLE 2

Cereal grain (sorghum and, if appropriate, maize) 23 is crushed by means of a rolling mill 20 and is mixed with a premix 21 of vitamins, mineral substances and/or other supplements in a mixer 2 and makes its way via a conveyor 3 into a dosing balance 4. From there, the mixture makes its way, with the addition of water 6 and steam 7, into a conditioner 5. The conditioned mixture then makes its way, if necessary with the further addition of water 9, into an extruder 8, where the mixture is heated under pressure and is processed mechanically, at the same time as it is conveyed through the workroom. Fat 10 and/or molasses/corn steep liquor 11 are also added separately. In the penultimate barrel of the extruder 8, a defined quantity of (preferably) wheat straw 13 is introduced, by means of a conveyor 14 (after a further dosing balance 12) and a pressure screw 15, and is mixed with the aforementioned mixture under pressure. Steam and/or pressure are also allowed to escape by means of a vent arrangement 16 ahead of this penultimate barrel of the extruder 8.

The feed then exits from the extruder 8 through an outlet orifice (not designated in more detail here) as a strand, which is reduced to the size of pellets by means of a cutting device 17.

### EXAMPLE 3

Cereal grain (sorghum and, if appropriate, maize) 23 is crushed by means of a rolling mill 20 and is mixed with a premix 21 of vitamins, mineral substances and/or other supplements in a mixer 2 and makes its way via a conveyor 3 into a dosing balance 4. From there, the mixture makes its way, with the addition of water 6 and steam 7, into a conditioner 5. The conditioned mixture then makes its way, if necessary with the further addition of water 9, into an expander 24, where the mixture is heated under pressure and is processed mechanically, at the same time as it is conveyed through the workroom. Fat 10 and/or molasses/corn steep liquor 11 are also added separately. A defined quantity of (preferably) wheat straw 13 is introduced into the expander 24 by means of a conveyor 14 (after a further dosing balance 12) and is mixed homogeneously with the aforementioned mixture.

The feed then exits from the expander 24 through an outlet orifice (not designated in more detail here) as a strand, which is reduced to the size of pellets by means of a cutting device 17.

These pellets find their way in each case into a receiving container 22, from where they are conveyed for further processing and use.

The pellets produced by way of example exhibit a density of 300-600 g/l and contain approx. 0-50% of wheat straw. The water content is 18-25%. The length of the straw fibres in the pellet is in the order of 1-10 cm.

The pellets exhibit dimensions of approx. 1-7 cm.

The pellets are very suitable for use as concentrated feeding stuffs and exhibit only a small fine fraction. The sugar and starch ingredients are gelatinized and bind the other ingredients together.

As a result of the better conversion, the feed also produces a lower yield of dung and liquid manure.

### List of Reference Designations

1 premix

2 mixer

3 conveyor

4 dosing balance

5 conditioner

6 water

7 steam

8 extruder

9 water

10 fat

11 molasses/corn steep liquor

12 dosing balance

13 wheat straw

14 conveyor

15 pressure screw

16 vent arrangement

17 cutting device

20 rolling mill

21 premix

22 receiving container

23 cereal grain

24 expander

1. Method for the manufacture of a compound feed for cattle or the like, comprising: mixing and conditioning a premix of cereal grain ingredients, fat, molasses, vitamins, minerals and/or other supplements with the addition of steam and water and then subjecting to mechanical and/or thermal treatment, wherein the mixture is heated, processed and formed into porous pellets.

2. Method according to claim 1, wherein the mechanical treatment takes place in one or a plurality of stages.

3. A compound feed for cattle or the like, which is treated mechanically and thermally according to claim 1 and is formed into agglomerated pellets and contains water, cereal grain components, fat, molasses, vitamins, minerals and/or other supplements together with 3-50% of straw, the cereal grain and starch components comprising sorghum, and the straw being wheat straw with a proportion of up to 50% in the compound feed, and the straw fibers exhibiting a length of 1-10 cm in the pellet.

4. Compound feed according to claim 3, wherein the density of the pellets is 300-600 g/l.

5. Compound feed according to claim 3, wherein the water content is 18-25%.

6. A method for using a compound feed according to claim 3 comprising using the compound as a starter feed and containing up to 50% of wheat straw.

7. A method for using a compound feed according to claim 3, comprising using the compound as a rearing feed and only contains a maximum of 8% straw.

8. (canceled)
